(19) United States
(12) Patent Application Publication
(10) Pub. No.: US 2004/0205970 A1
(43) Pub. Date: Oct. 21, 2004

(54) Glass cutter

(76) Inventor: Asako Arai, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/817,920

(22) Filed: Apr. 6, 2004

(30) Foreign Application Priority Data
Apr. 17, 2003 (JP) 2003-112676

(51) Int. Cl. B26B 3/00

(52) U.S. Cl. 30/164.95; 30/276

(57) ABSTRACT

A glass cutter is provided which can reduce and stabilize the force applied to the cutter wheel by applying cutting pressure to the cutter wheel with a weight, and with which can reliably form scribe lines even if the size of the glass is large or the work position is unstable due to work environments. In a glass cutter having a cutter wheel on the cutter body, a bar is provided on the tip of the cutter body so as to be pivotable. A weight is mounted on the tip of the bar to apply cutting pressure to the cutter wheel, thereby reducing the force required during cutting.

### BACKGROUND OF THE INVENTION

This invention relates to a glass cutter for scribing scribe lines on a surface of sheet glass with a cutter wheel provided at its head when cutting the glass.

Glass cutters for scribing scribe lines on the surface of glass have a cutter wheel rotatably mounted on the head of the cutter body. Such glass cutters include a horizontal type in which the cutter body is formed by providing a downward head at the tip of the grip, which is gripped in a horizontal state, and rotatably mounting the cutter wheel on the head, and a vertical type in which the cutter body is formed by providing the head at the bottom end of a vertically elongated shaft-like grip and rotatably mounting the cutter wheel on the head.

In order to cut glass with one of such cutters, in either type, the cutter wheel is pressed against the surface of glass while gripping the grip and the glass cutter is pulled toward the operator so that the cutter wheel rolls while being pressed, thereby scribing with the cutter wheel a scribe line on the surface of the glass along which the glass is to be bent and cut (see JP patent publication 2001-48563).

In such a glass cutter, an operator exerts his own force to press and roll the cutter wheel. If the glass size is large or the working position is unstable due to work environments, the force applied to the cutter wheel may be insufficient. Thus, particularly in cutting expensive and thick glass, scribe lines cannot be formed as intended.

Also, in cutting stained glass, since scribe lines are formed tracing a preset paper pattern, it is necessary to control the movement of the cutter wheel. Thus, stronger force is needed than when cutting ordinary glass sheets. Thus, cutting a large quantity of stained glass for a long time is an extremely painful job.

Further, with a glass cutter of a type in which the cutter wheel rolls, straight advancing properties of the cutter wheel are inferior. Thus, in cutting the glass, the cutter wheel tends to get off the ruler. This causes failure in cutting.

An object of this invention is to provide a glass cutter which can, in scribing scribe lines on glass by pressing and rolling the cutter wheel, reduce and stabilize the force applied to the cutter wheel by exerting cutting pressure on the cutter wheel with a weight, reliably form scribe lines even if the size of glass is large or the working position is insufficient due to work environments, and accurately scribe scribe lines along a ruler.

### SUMMARY OF THE INVENTION

According to this invention, there is provided a glass cutter comprising a cutter body, a head formed on the cutter body, a cutter wheel mounted on the head of the cutter body, and a weight mounted on the cutter body for applying cutting pressure on the cutter wheel to reduce the force applied during cutting.

The weight may be provided at the tip of a bar mounted on the cutter body. The bar may be shrinkable or may be mounted on the cutter body so as to be pivotable.

An electric vibrator may be mounted on the bar, or a guide member to be pressed against a ruler may be detachably mounted on the head of the cutter.

The cutter body may be either of a horizontal type which is formed by providing a head at the tip of the grip, which is gripped in a horizontal state, and has a cutter wheel rotatably mounted on the head, or a vertical type in which the cutter body 2 includes a head on the bottom end of a vertically elongated shaft-like grip and a cutter wheel rotatably mounted to the head.

In the horizontal type, if the bar is a fixed type, it is provided so as to protrude from the longitudinal tip of the grip so as to extend forwardly. If it is shrinkable, it is adapted to be received in the grip. If the bar is shrinkable, it is possible to change the distance between the weight and the cutter wheel, and thus to freely adjust the cutting pressure applied to the cutter wheel from the weight.

Also in the vertical type, if the bar is of a fixed type, it is mounted so as to protrude rearwardly, from the bottom of the grip. If it is pivotable, when pulled up, it can be folded along the grip.

The guide member to be pressed against the ruler has plate-like guide pieces which are flush with or slightly protrude from the other side of the head at both ends of a groove portion which fits on the head from one side, and is detachable by fixing the groove portion to the head with screws.

### BRIEF DESCRIPTION OF THE DRAWINGS

Other features and objects of the present invention will become apparent from the following description made with reference to the accompanying drawings, in which:

FIG. 1A is a partially cutaway front view showing a first embodiment of the glass cutter according to this invention;

FIG. 1B is a plan view of the same;

FIG. 2A is a front view showing a second embodiment of the glass cutter;

FIG. 2B is an enlarged front view with the bar shrunk;

FIG. 3 is a front view showing a third embodiment of the glass cutter;

FIG. 4 is a vertical sectional front view of the same in use while cutting glass;

FIG. 5A is an enlarged front view of the guide member; and

FIG. 5B is an enlarged cross-sectional plan view with the guide member mounted on the head of the glass cutter.

### DETAILED DESCRIPTION OF THE PREFERRED EMBODIMENT

The embodiments of this invention will be described with reference to the drawing.

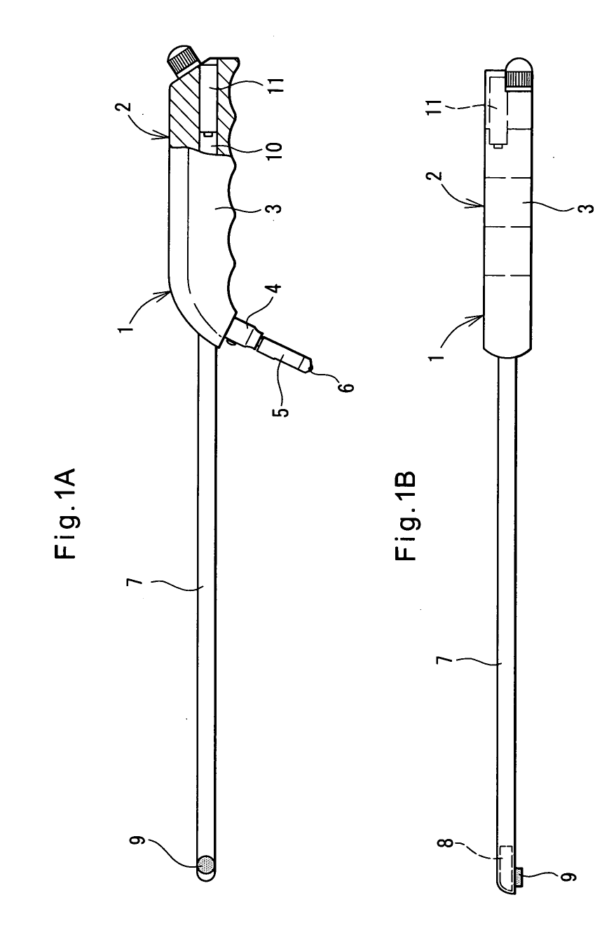

The glass cutter 1 of the first embodiment shown in FIG. 1 is an example of a horizontal type. The cutter body 2 includes an obliquely forwardly and downwardly protruding mounting member 4 at the tip of a grip 3 which is to be gripped in a horizontal state, a head 5 at the tip of the mounting member 4, and a cutter wheel 6 rotatably mounted on a bifurcated tip of the head 5. A bar 7 is provided on the grip 3 so as to extend forwardly from its tip in the longitudinal direction. A weight 8 is mounted on the tip of the bar 7 to apply a cutting pressure to the cutter wheel 6 using the lever principle, thereby reducing the force during cutting.

The bar 7 is a pipe of e.g. a metal. The weight 8, which is made of a metal having a large specific weight, is fixed thereto by filling or mounting in the internal space at its tip. On the outer surface of the bar 7 at its tip, an ultra-small electric vibrator 9 is mounted to impart vibrations to the cutter wheel 6 through the bar 7.

As the power source of the vibrator 9, a battery 11 is received in an openable chamber 10 formed in the grip 3 and the vibrator 9 and the battery 11 are connected together by wiring through a switch (not shown) so that the activation of the vibrator 9 can be controlled by turning on and off the switch.

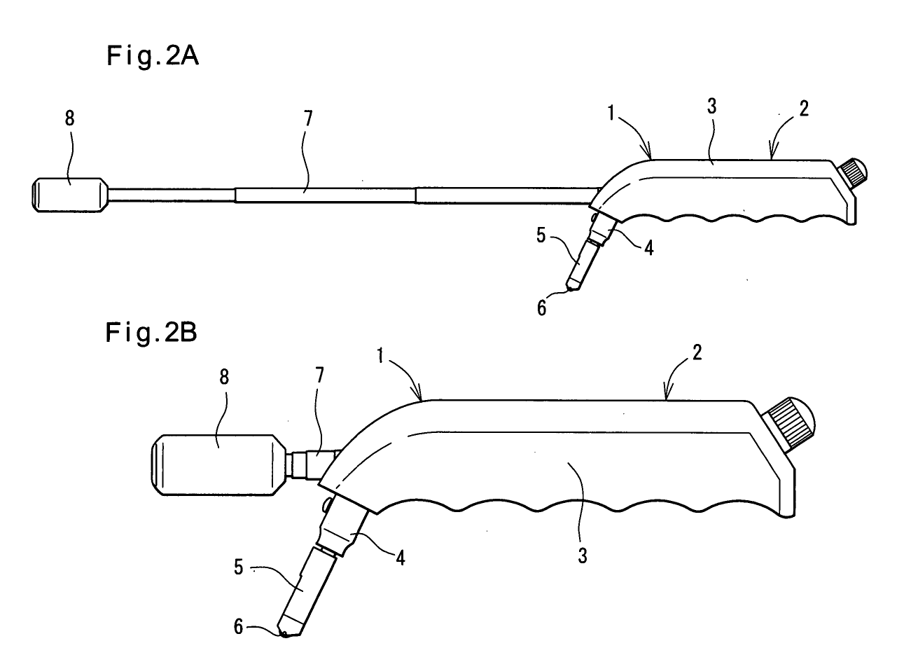

The glass cutter 1 of the second embodiment, shown in FIG. 2, is an example of a horizontal type in which the bar 7 is extendible.

The bar 7 is substantially as long as the grip, and formed extendible by fitting a plurality of pipes having different diameters one on another. The largest-diameter pipe is fixed by fitting in a longitudinal groove formed in the top surface of the grip 3 so that the other pipes can be moved into and out of the tip of the grip. A weight 8 is mounted on the tip of the smallest-diameter pipe, so that with the bar 7 shrunk by pushing the smaller-diameter pipes into the larger-diameter ones, only the weight 8 protrudes from the tip of the grip 3.

In the second embodiment, by shrinking the bar 7, it is possible to freely change the distance of the weight 8 relative to the cutter wheel 6 by expanding the bar 7. Thus, if with the cutter wheel 6 abutting the glass surface, the distance of the weight 8 relative to the cutter wheel 6 is increased, the cutting pressure imparted to the cutter wheel 6 increases under the lever principle. Also, by reducing the distance of the weight 8 relative to the cutter wheel 6, the cutting pressure decreases. Thus, by adjusting the amount of shrinkage and extension of the bar 7, it is possible to freely adjust the cutting pressure applied to the cutter wheel 6.

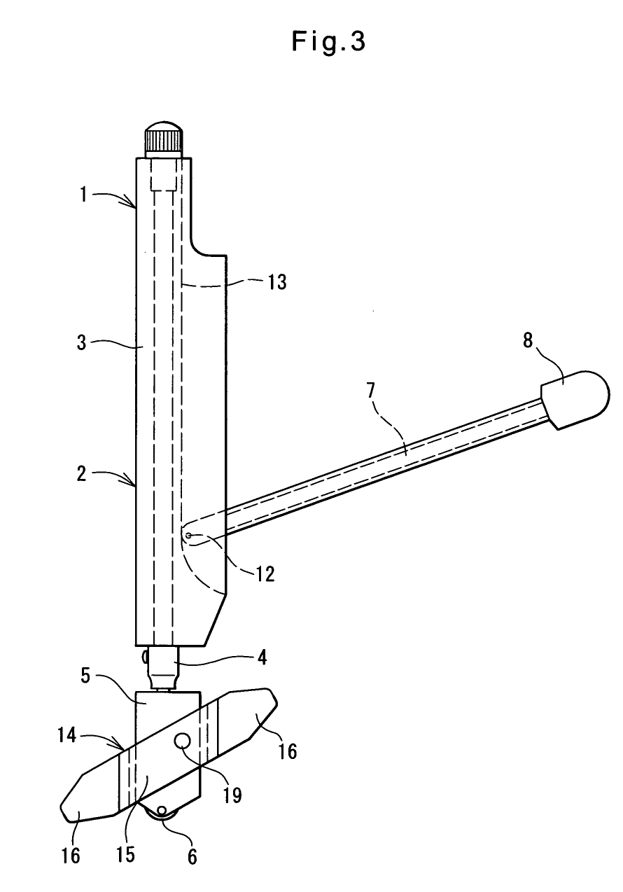

The glass cutter 1 of the third embodiment, shown in FIG. 3, is an example of a vertical type in which the cutter body 2 includes a head 5 on the bottom end of a vertically elongated shaft-like grip 3 through a mounting member 4, and a cutter wheel 6 rotatably mounted to the head 5. A bar 7 is mounted to the lower portion of the grip 3 so as to protrude from the grip 3 toward the rear with an obliquely upward inclination. A weight 8 is provided at the tip of the bar 7.

In the glass cutter 1 of the third embodiment, the bar 7 has its bottom end pivotally coupled to the grip 3 so as to be pivotable about a pivot 12 relative to the grip 3. When fallen, the bar 7 is adapted to protrude from the grip 3 toward the rear with an obliquely upward inclination, and when raised, it is adapted to be foldable so as to be received in a groove 13 formed in the grip 3. In the third embodiment, as in the second embodiment, the bar 7 may be formed so as to be expandable.

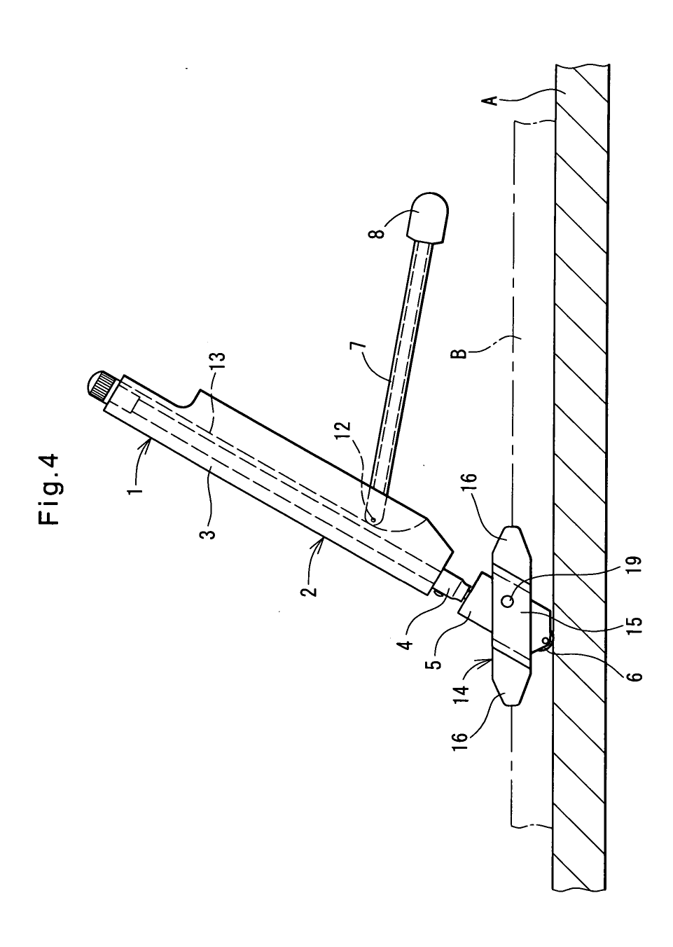

As in FIGS. 3 and 4, in this glass cutter 1, a guide member 14 for moving the head 5 along a ruler B on glass A may be detachably mounted to the head 5.

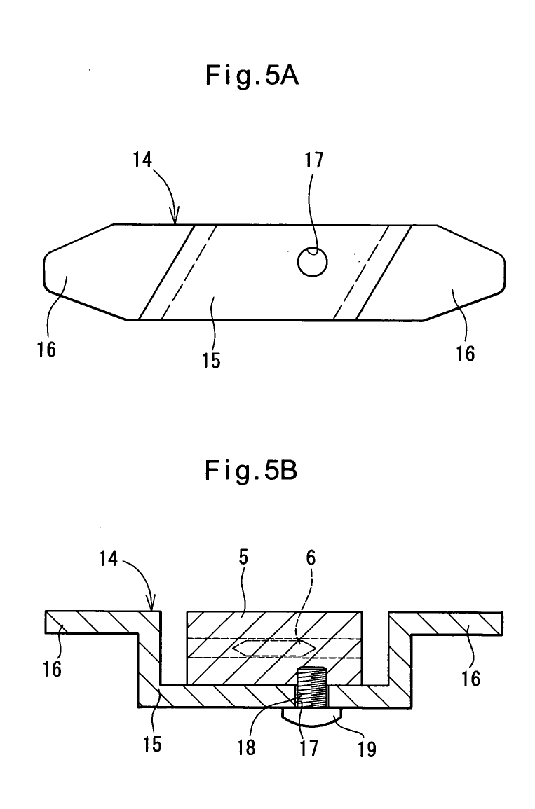

As shown in FIG. 5B, the guide member 14 has a groove-shaped portion 15 which receives the head 5 and includes plate-like guide pieces 16 which are flush with or slightly protrude from the other side of the head 5, integrally formed at both ends of the groove-shaped portion 15 so as to protrude in opposite directions by a predetermined length. The groove-shaped portion 15 is fixed by a screw 19 threaded through a lateral hole 17 of the groove-shaped portion 15 into a threaded hole 18 formed in the head 5. As shown in FIG. 4, the guide member 14 is mounted to the head 5 with an inclination angle so that when the grip 3 is held at a predetermined cutting angle, the guide member 14 will be horizontal.

The guide member 14 has its groove-shaped portion 15 fitted on the head 5 with some play so that the guide member 14 is pivotable about the screw 19 within the range of the play so that even if the cutting angle of the grip changes slightly, it will be horizontal.

Since the guide member 14 has its guide pieces 16 flush with or slightly protruding from the other side of the head 5, when both guide pieces 16 are pressed against the ruler B, the abutting surface is enlarged. Thus they stably abut the ruler B and it is possible to accurately move the rolling cutter wheel 6 along the ruler B.

Such a guide member 14 can be mounted to the glass cutters 1 of the first and second embodiments, too, and also can be mounted to the head of any existing glass cutter.

In the glass cutter 1 of any of the above embodiments, the length of the bar 7 is preferably set at about 40-300 mm, and the weight of the weight 8 is preferably set at about 5-800 g.

In the glass cutter 1 of any of the embodiments, oil is filled in the grip 3 to supply oil to the cutter wheel 6 during cutting.

The glass cutter 1 of this invention is structured as described above. By pressing the cutter wheel 6 against the surface of glass A to be cut while gripping the grip 3 and pulling it toward the operator, scribe lines are formed on the surface of the glass A with the rolling cutter wheel 6.

When forming scribe lines with the cutter wheel 6 of the glass cutter 1, since the weight 8 is mounted on the grip 3 through the bar 7 at a position apart from the cutter wheel 6, the weight of the weight 8 acts additionally on the cutter wheel 6 under the lever principle, so that the weight of the weight 8 adds to the pressing force of the cutter wheel 6. By applying the cutting pressure to the cutter wheel 6 with the weight 8, it is possible to reduce the force applied to the cutter wheel 6 and stabilize it. Thus, even if the size of the glass A is large, even when cutting stained glass, or even if the working position is unstable due to work environments, scribe lines can be reliably formed with light force.

As for the load to be manually applied to the cutter wheel, about 3-8 kg was needed heretofore. But in this invention, by mounting the weight 8 through the bar 7 at a position apart from the cutter wheel 6, and thereby applying the weight of the weight 8 additionally to the cutter wheel 6, the load to be manually applied to the cutter wheel 6 can be reduced to about 0.5-1.5 kg. Thus it is possible to cut glass plates, thin or thick, with such a reduced force without any possibility of failure in cutting.

The load applied to the cutter wheel 6 by the weight 8 which is mounted at the tip of the bar 7, can be determined by the following equation:

X=d+a/2b(2m+M)

Wherein

X: load applied to the cutter wheel

m: weight of the weight

M: total weight of the bar and the glass cutter

a: entire length of the bar

b: length from the fixing point of the bar to the head

d: weight of the head

By mounting the guide member 14 to the head 5 of the glass cutter 1 and scribing scribe lines with the guide member 14 in abutment with the guide edge of the ruler B, the abutting surface with the ruler B can be enlarged by the guide member 14. Since the guide pieces 16 are flush with or protrude from the other side of the head 5, the abutting surface when the guide pieces 16 are pressed against the ruler B are enlarged, so that the abutting state against the ruler B stabilizes. This makes it possible to accurately move the rolling cutter wheel 6 along the ruler B.

By activating the vibrator 9 when scribing scribe lines, vibrations are applied to the cutter wheel 6. This further improves the scribing efficiency.

As described above, according to this invention, the weight is mounted to the cutter body provided with the cutter wheel to additionally apply the cutting pressure to the cutter wheel. Thus, when scribing scribe lines with the cutter wheel, the weight of the weight acts on the cutter wheel. Thus, the weight of the weight adds to the pressing force of the cutter wheel as the cutting pressure, so that it is possible to reduce the force manually applied to the cutter wheel and thus to stabilize it. Further, by mounting the weight on the tip of the bar protruding from the grip, it is possible to apply the added weight of the weight to the cutter wheel by the lever principle. Thus, even if the size of the glass is large, even when cutting stained glass, or even if the working position is unstable due to working environments, it is possible to reliably form scribe lines with light force.

If the bar is shrinkable, it is possible to freely adjust the weight applied to the cutter wheel. If the vibrator is mounted on the bar to which is mounted the weight, it is possible to impart vibrations to the cutter wheel. This further improves the efficiency in scribing scribe lines.

Further, if the guide member is mounted on the head of the glass cutter, the abutting surface is enlarged when it is pressed against a ruler. Thus the abutting state against the ruler stabilizes, which makes it possible to accurately move the rolling cutter wheel along the ruler.

1. A glass cutter comprising a cutter body, a head formed on said cutter body, a cutter wheel mounted on said head of said cutter body, and a weight mounted on said cutter body for applying cutting pressure on said cutter wheel to reduce the force applied during cutting.

2. A glass cutter as claimed in claim 1 wherein said weight is provided at the tip of a bar mounted on said cutter body.

3. A glass cutter as claimed in claim 2 wherein said bar is shrinkable.

4. A glass cutter as claimed in claim 2 wherein said bar is mounted on said cutter body so as to be pivotable.

5. A glass cutter as claimed in claim 2 wherein an electric vibrator is mounted on said bar.

6. A glass cutter as claimed in claim 1 wherein a guide member to be pressed against a ruler is detachably mounted on the head of said cutter body.

7. A glass cutter as claimed in claim 3 wherein said bar is mounted on said cutter body so as to be pivotable.

8. A glass cutter as claimed in claim 3 wherein an electric vibrator is mounted on said bar.

9. A glass cutter as claimed in claim 4 wherein an electric vibrator is mounted on said bar.

10. A glass cutter as claimed in claim 2 wherein a guide member to be pressed against a ruler is detachably mounted on the head of said cutter body.

11. A glass cutter as claimed in claim 3 wherein a guide member to be pressed against a ruler is detachably mounted on the head of said cutter body.

12. A glass cutter as claimed in claim 4 wherein a guide member to be pressed against a ruler is detachably mounted on the head of said cutter body.

13. A glass cutter as claimed in claim 5 wherein a guide member to be pressed against a ruler is detachably mounted on the head of said cutter body.
